(19) United States
(12) Patent Application Publication
(10) Pub. No.: US 2025/0267483 A1
(43) Pub. Date: Aug. 21, 2025

(54) METHOD AND SYSTEM FOR BENCHMARKING AND TESTING OF RADIO ACCESS NETWORK INTELLEGENT CONTROLLERS

(71) Applicant: HCL Technologies Limited, Delhi (IN)

(72) Inventors: Ramesh Sriraman, Chennai (IN); Sandeep Kumar, Watford (IN); Sanket Bejagamwar, Watford (GB)

(21) Appl. No.: 19/010,048

(22) Filed: Jan. 5, 2025

(30) Foreign Application Priority Data
Feb. 21, 2024 (IN) 202411012240

(51) Int. Cl. H04W 24/06; H04L 41/5003; H04W 92/12

(52) U.S. Cl. CPC H04W 24/06; H04L 41/5003; H04W 92/12

(57) ABSTRACT

This disclosure relates to method and system for benchmarking and testing of a Radio Access Network (RAN) Intelligent Controller (RIC). The method includes integrating a plurality of RAN simulation functionalities associated with an E2-node simulator into a network component including a plurality of benchmarking functionalities associated with a benchmarking application. The method further includes deploying the network component on a RAN Intelligent Controller (RIC). The method further includes initiating a communication between the network component and an E2-terminator of the RIC.

### TECHNICAL FIELD

This disclosure relates generally to the field of communication networks, and more particularly to method and system for benchmarking and testing of a Radio Access Network (RAN) Intelligent Controller (RIC).

### BACKGROUND

In the field of telecommunications, a Radio Access Network (RAN) helps facilitate wireless communication between user devices and a core network. The RAN includes various components such as base stations, antennas, and transceivers that form a physical infrastructure for transmitting and receiving radio signals. Evolution of the RAN is marked by advancements in technologies like Fifth Generation (5G) which aim to provide higher data rates, lower latency, and increased connectivity for a diverse range of devices. Further, a RAN Intelligent Controller (RIC) is a crucial part of 5G networks which helps improve efficiency, responsiveness, and operations of the RAN. Currently, RIC benchmarking includes two components including an E2-node simulator which mimics the RAN, and a benchmarking application. These components operate independently. The benchmarking application functions as a third-party application within an RIC architecture. The E2-node simulator acts as a southbound entity, essentially emulates behaviour of the RAN.

Despite advancements in RIC technology, there are various inherent challenges in benchmarking and measuring latency at various levels within the system. As the E2-node simulator and the benchmarking application are two separate components of the RIC benchmarking, it poses difficulties in achieving comprehensive latency measurements. Further, management and coordination of these components separately adds complexity to the overall system. It can lead to inefficiencies in terms of deployment, configuration, and maintenance, making an RIC benchmarking process less streamlined. Additionally, use of third-party E2node simulators can be prohibitively expensive. Moreover, these two separate components may limit scalability and adaptability of the RIC benchmarking, especially in the context of evolving network architectures and technologies.

The present invention is directed to overcome one or more limitations stated above or any other limitations associated with the known arts.

### SUMMARY

In one embodiment, a method for benchmarking and testing of a Radio Access Network (RAN) Intelligent Controller (RIC) is disclosed. In one example, the method may include integrating a plurality of RAN simulation functionalities associated with an E2-node simulator into a network component including a plurality of benchmarking functionalities associated with a benchmarking application. The method may further include deploying the network component on a RAN Intelligent Controller (RIC). The method may further include initiating a communication between the network component and an E2-terminator of the RIC.

In another embodiment, a system for benchmarking and testing of a Radio Access Network (RAN) Intelligent Controller (RIC) including a benchmarking and testing device is disclosed. In one example, the benchmarking and testing device may include a processor and a memory communicatively coupled to the processor. The memory may store processor-executable instructions, which, on execution, cause the processor to integrate a plurality of RAN simulation functionalities associated with an E2-node simulator into a network component including a plurality of benchmarking functionalities associated with a benchmarking application. The processor-executable instructions, on execution, may further cause the processor to deploy the network component on a RAN Intelligent Controller (RIC). The processor-executable instructions on execution may further cause the processor to initiate a communication between the network component and an E2-terminator of the RIC.

In yet another embodiment, a network component deployed on a RAN Intelligent Controller (RIC) is disclosed. In one example, the network component may include a plurality of RAN simulation functionalities associated with an E2-node simulator. The network component may further include a plurality of benchmarking functionalities associated with a benchmarking application. It should be noted that the plurality of RAN simulation functionalities is integrated with the plurality of benchmarking functionalities.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an Open Radio Access Network (ORAN) environment where various embodiments of the present invention may be employed.

FIG. 2 is a block diagram of a system for benchmarking and testing of a Radio Access Network (RAN) Intelligent Controller (RIC), in accordance with some embodiments.

FIG. 3 illustrates a block diagram of various modules within a memory of a benchmarking and testing device, in accordance with some embodiments.

FIG. 4 is a functional block diagram of a Radio Access Network (RAN) Intelligent Controller (RIC) with combined RAN simulation functionalities and benchmarking functionalities, in accordance with some embodiments.

FIG. 5 illustrates a flow diagram of an exemplary process for benchmarking and testing of a Radio Access Network (RAN) Intelligent Controller (RIC), in accordance with some embodiments.

FIG. 6 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

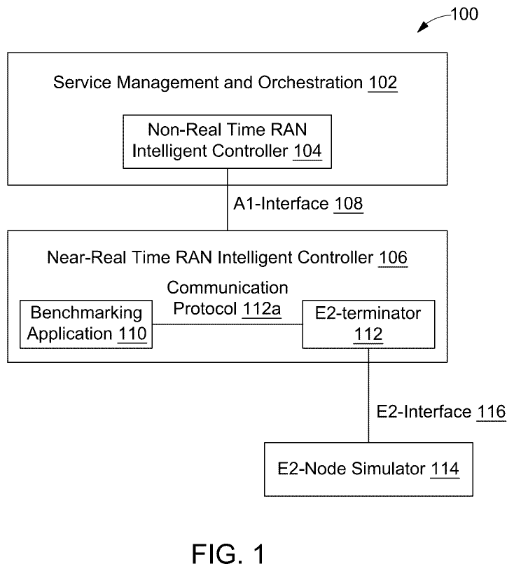

Referring now to FIG. 1, an Open Radio Access Network (ORAN) environment 100 where various embodiments of the present invention may be employed is illustrated, in accordance with some embodiments. The ORAN environment 100 may include a Service Management and Orchestration (SMO) 102 that manages and coordinates various network functions, configurations, and service delivery tasks. The SMO 102 ensures that different components work in harmony to meet service requirements efficiently. The SMO 102 helps allocate and manage network resources, including spectrum, bandwidth, and hardware components. Further, the SMO 102 optimizes resource usage to enhance the overall performance of RAN. The SMO 102 oversees configurations of RAN components, such as base stations and antennas, ensuring they are appropriately set up to meet service-level agreements and performance expectations.

Further, the SMO 102 actively monitors the RAN for any faults or issues. For example, when any problem is detected, the SMO 102 initiates corrective actions or communicates with relevant components to resolve issues promptly and minimize service disruptions. Additionally, the SMO 102 continuously analyzes performance metrics of the RAN to identify areas for improvement. The SMO 102 implements optimization strategies to enhance network efficiency, coverage, and quality of service.

It may be apparent to a person skilled in the art that the SMO 102 collaborates closely with RAN Intelligent Controllers (RICs), both a non Real-Time (RT) RIC 104 and a near RT-RIC 106, to exchange information, receive updates, and provide instructions for long-term planning and immediate operational adjustments, respectively.

The SMO 102 communicates with the non RT-RIC 104 for longer-term planning, strategic decision-making, and optimization strategies based on historical data and trends, and the near RT-RIC 106 for more immediate decision-making and adjustments, responding to current operational needs and dynamic changes in network environment. These interactions through the standardized communication interfaces ensure that the SMO 102 may provide instructions, receive updates, and maintain a synchronized and adaptive RAN environment.

The non RT-RIC 104 communicates with the SMO 102 to receive configuration instructions, share optimization strategies, and provide status updates on network performance over extended periods. The near RT-RIC 106 interacts with the SMO 102 for real-time updates, receiving immediate instructions for dynamic adjustments to enhance the adaptability and responsiveness of the network. The A1 interface 108 acts as a standardized communication interface, facilitating interactions between the non RT-RIC 104 and the near RT-RIC 106. It should be noted that RICs are separately referred to as the non RT-RIC 104 and the near RT-RIC 106, and collectively referred to as RICs 104, 106. The A1 interface 108 enables bidirectional communication between the RICs 104, 106, ensuring seamless exchange of commands, configuration data, and performance metrics.

The near RT-RIC 106 includes a benchmarking application 110, and an E2-terminator 112. The benchmarking application 110 provides benchmarking functionalities for RIC performance evaluation. The benchmarking application 110 is responsible for initiating and conducting performance evaluations and tests on the RIC. The benchmarking application 110 generates commands, queries, or scenarios to assess efficiency and responsiveness of the RIC components. The benchmarking application 110 communicates with the E2-terminator 112 through the communication protocol 112a. Examples of the communication protocol 112a may include, but not limited to, an RIC Message Router (RMR), a Representational State Transfer (REST), and a Remote Procedure Call (RPC). The benchmarking application 110 sends benchmarking commands, queries, or instructions to the E2-terminator 112 for further processing.

The E2-terminator 112 acts as an interface termination point in an E2 protocol. The E2-terminator 112 receives messages from the benchmarking application 110 through the communication protocol 112a. The E2-terminator 112 interprets the received benchmarking commands, queries, or instructions and forwards them to the appropriate components (such as an E2-node simulator 114) within the ORAN environment 100, facilitating the emulation of RAN behavior. Further, the E2-node simulator 114 emulates behavior of the RAN for benchmarking and application development purposes. The E2-node simulator 114 receives instructions or scenarios from the E2-terminator 112 via an E2-interface 116, simulating responses of the RAN components. The E2-node simulator 114 generates simulated data and events, mimicking behavior of actual RAN.

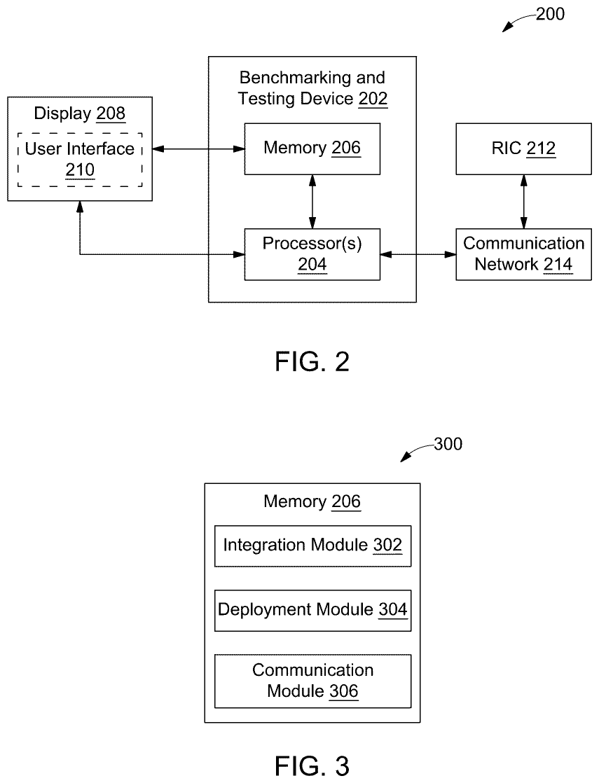

The E2-node simulator 114 provides feedback, metrics, or simulated responses (i.e. the simulated data) to the E2-terminator 112 via the E2 interface 116, helping in benchmarking of RIC components under given benchmarking conditions. The E2-terminator 112, using the communication protocol 112a, communicates the simulated data back to the benchmarking application 110 that may help in latency calculation, throughput measurement, or evaluation of any other relevant performance metrics of RIC. Further, the benchmarking application 110 analyzes the received simulated data from the E2-terminator 112 to evaluate performance of the RIC under specified conditions. The benchmarking application 110 generates reports, logs, or visualizations based on benchmarking results. Further, integration of the RAN simulation functionalities associated with the E2-node simulator 114 and benchmarking functionalities of the benchmarking application 110 into a single network component of the near RT-RIC 106 is explained in detail in conjunction with FIGS. 2-6. The integration may be advantageous in terms of various factors including but not limited to cost of the E2-node simulators, latency measurement, and scalability and adaptability of the RIC benchmarking.

Referring now to FIG. 2, a block diagram of a system 200 for benchmarking and testing of a Radio Access Network (RAN) Intelligent Controller (RIC) 212 (for example, the near-RT RIC 106) is illustrated, in accordance with some embodiments. The system 200 may implement a benchmarking and testing device 202 (for example, a desktop, a laptop, a notebook, a netbook, or any other computing device), in accordance with some embodiments of the present disclosure. The benchmarking and testing device 202 may benchmark and test the RIC 212.

As will be described in greater detail in conjunction with FIGS. 3-6, the benchmarking and testing device 202 may integrate a plurality of RAN simulation functionalities associated with an E2-node simulator (such as the E2-node simulator 114) into a network component including a plurality of benchmarking functionalities associated with a benchmarking application (such as the benchmarking application 110). The benchmarking and testing device 202 may further deploy the network component on the RIC 212. The benchmarking and testing device 202 may further initiate a communication between the network component and an E2-terminator (such as the E2-terminator 112) of the RIC 212. The benchmarking and testing device 202 is further explained in detail in conjunction with FIG. 3.

In some embodiments, the benchmarking and testing device 202 may include one or more processors 204 and a memory 206. The memory 206 may include a database (not shown in FIG. 2). The memory 206 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.)

Further, the memory 206 may store instructions that, when executed by the one or more processors 204, cause the one or more processors 204 to benchmark and test the RIC 212. The memory 206 may also store various data (for example, the RAN simulation functionalities, the plurality of benchmarking functionalities, latency measurements, benchmarking instructions, and the like) that may be captured, processed, and/or required by the system 200.

The system 200 may further include a display 208. The system 200 may interact with a user via a user interface 210 accessible via the display 208. In some embodiments, the benchmarking and testing device 202 may render results to the user via the user interface 210. In some embodiments, the benchmarking and testing device 202 may interact with the RIC 212 over a communication network 214 for sending or receiving various data. The communication network 214, for example, may be any wired or wireless communication network and the examples may include, but may be not limited to, the Internet, Wireless Local Area Network (WLAN), Wi-Fi, Long Term Evolution (LTE), Worldwide Interoperability for Microwave Access (WiMAX), and General Packet Radio Service (GPRS). In some embodiments, the benchmarking and testing device 202 may deploy the network component on the RIC 212.

Referring now to FIG. 3, a block diagram 300 of various modules within the memory 206 of the benchmarking and testing device 202 is illustrated, in accordance with some embodiments. FIG. 3 is explained in conjunction with FIG. 2. The memory 206 may include an integration module 302, a deployment module 304, and a communication module 306. The memory 206 may also include a datastore (not shown in FIG. 3) to store various data and intermediate results generated through the modules 302-306.

In some embodiments, the integration module 302 may receive a plurality of RAN simulation functionalities associated with an E2-node simulator (such as the E2-node simulator 114). The plurality of RAN simulation functionalities may provide capabilities to simulate behavior and operations of the RAN. This may include emulating interactions, protocols, and responses of the RAN components, such as base stations and mobile devices. Further, the integration module 302 may integrate the plurality of RAN simulation functionalities associated with the E2-node simulator into a network component that includes a plurality of benchmarking functionalities associated with a benchmarking application (such as the benchmarking application 110). An example of the benchmarking application may include, but is not limited to, a Bouncer xApp®.

In other words, the integration module 302 may combine the plurality of RAN simulation functionalities from the E2-node simulator with the plurality of the benchmarking functionalities associated with the benchmarking application. This consolidation may generate a unified component (i.e., the network component) that may both simulate RAN behavior and perform benchmarking activities. The integration may create a comprehensive testing and benchmarking environment. It should be noted that the network component including a combination of the plurality of RAN simulation functionalities and the plurality of benchmarking functionalities may be used for evaluating performance, responsiveness, and efficiency of the RIC under various conditions. The integration module 302 may be communicatively coupled to the deployment module 304.

The deployment module 304 may be configured to deploy the network component on an RIC (for example, the near RT-RIC 106). The RIC may be responsible for implementing intelligent control mechanisms within the RAN. This deployment of the network component onto the RIC is to leverage capabilities of the network component for benchmarking and testing the RIC. Further, the integrated functionalities including the plurality of RAN simulation functionalities and the plurality of benchmarking functionalities become a part of RIC's capabilities. The deployment module 304 may be communicatively coupled to the communication module 306.

In some embodiments, the communication module 306 may initiate a communication between the network component and an E2-terminator (such as the E2-terminator 112) of the RIC. In one embodiment, to initiate the communication, an E2-setup request may be sent from the network component to the E2-terminator. The E2-setup request may be a message including information about setup or configuration required for communication. For example, the network component may send the E2-setup request to the E2-terminator, specifying parameters needed for interaction.

In one embodiment, in response to sending the E2-setup request, an E2-setup response from the E2-terminator may be received by the network component. The E2-setup response acknowledges the E2-setup request and may include additional information. For example, the E2-terminator may establish necessary configuration, and respond with the E2-setup response, indicating that the setup is complete. Further, in one embodiment, a latency between the E2-setup request and the E2-setup response may be determined through the network component. Once the E2-setup request is sent to the E2-terminator, the network component measures time taken to receive the E2-setup response. This duration may be referred to as the latency that represents the time delay between initiation of the communication and the acknowledgment received. For example, the network component may record timestamps when the E2-setup request is sent and when the E2-setup response is received. Further, the latency may then be calculated as a difference between these two timestamps.

Further, in some embodiments, a subscription request latency may be determined through the network component 410. The subscription request latency may be referred to time taken between sending a subscription request from the network component 410 to the E2-terminator 412 and receiving the subscription request from the E2-terminator 412 by the network component 410. Also, in some embodiments, an indication request latency may be determined through the network component 410. The indication request latency may be referred to time taken between sending an indication request from the network component 410 to the E2-terminator 412 and receiving the indication request from the E2-terminator 412 by the network component 410.

The latency may be determined for assessing responsiveness and efficiency of the communication between the network component and the E2-terminator. A latency determination may provide insights into the time taken for setup process. By way of an example, if the calculated latency is too high, it may indicate potential performance issues that need attention, such as delays in message processing or network congestion.

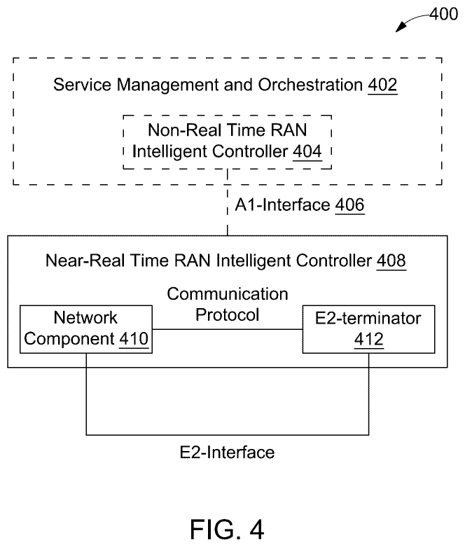

Referring now to FIG. 4, a functional block diagram 400 of a Radio Access Network (RAN) Intelligent Controller (RIC) with combined RAN simulation functionalities and benchmarking functionalities is illustrated, in accordance with some embodiments. FIG. 4 is explained in conjunction with FIGS. 1-3. The block diagram 400 includes a Service management and Orchestration (SMO) 402 (same as the SMO 102), a non RT-RIC 404 (same as the non RT-RIC 104), an A1 interface 406 (same as the A1 interface 108), and a near RT-RIC 408 (for example the near RT-RIC 106). The near RT-RIC 408 may be deployed with a network component 410. Further, the near RT-RIC 408 may include an E2-terminator 412 (such as the E2-terminator 112). The network component 410 may include a plurality of RAN simulation functionalities associated with an E2-node simulator (such as the E2-node simulator 114), and plurality of benchmarking functionalities associated with a benchmarking application (such as the benchmarking application 110).

In some embodiment, the network component 410 may communicate with the E2-terminator 412. The network component 410 may send an E2-setup request to the E2-terminator 412 via an E2-Interface using Stream Control Transmission Protocol (SCTP) connection. The network component 410 may receive an E2-setup response, in response to sending the E2-setup request, from the E2-terminator 412. Further, the network component 410 may determine a latency between the E2-setup request and the E2-setup response. Once the E2-setup request is sent to the E2-terminator 412, the network component 410 may measure time taken to receive the E2-setup response. This duration may be referred to as the latency that represents the time delay between initiation of the communication and an acknowledgment received. For example, the network component 410 may record timestamps when the E2-setup request is sent and when the E2-setup response is received. Further, the latency may then be calculated as a difference between these two timestamps. Additionally, in some embodiments, potential E2-connections may be determined, and one or more E2-nodes may be configured, through the network component 410. Moreover, in some embodiments, a control request latency may be determined through the network component 410. The control request latency may be referred to time taken between sending a control request from the network component 410 to the E2-terminator 412 and receiving the control request from the E2-terminator 412 by the network component 410. Further, in some embodiments, a subscription request latency may be determined through the network component 410. The subscription request latency may be referred to time taken between sending a subscription request from the network component 410 to the E2-terminator 412 and receiving the subscription request from the E2-terminator 412 by the network component 410. Also, in some embodiments, an indication request latency may be determined through the network component 410. The indication request latency may be referred to time taken between sending an indication request from the network component 410 to the E2-terminator 412 and receiving the indication request from the E2-terminator 412 by the network component 410.

It should be noted that the system 200, the benchmarking and testing device 202, and the network component 410 may be implemented in programmable hardware devices such as programmable gate arrays, programmable array logic, programmable logic devices, or the like. Alternatively, the system 200, the benchmarking and testing device 202, and the network component 410 may be implemented in software for execution by various types of processors. An identified engine/module of executable code may, for instance, include one or more physical or logical blocks of computer instructions which may, for instance, be organized as an object, module, procedure, function, or other construct. Nevertheless, the executables of an identified engine/module need not be physically located together but may include disparate instructions stored in different locations which, when joined logically together, comprise the identified engine/module and achieve the stated purpose of the identified engine/module. Indeed, an engine or a module of executable code may be a single instruction, or many instructions, and may even be distributed over several different code segments, among different applications, and across several memory devices.

As will be appreciated by one skilled in the art, a variety of processes may be employed for benchmarking and testing of a Radio Access Network (RAN) Intelligent Controller (RIC). For example, the system 200, the benchmarking and testing device 202, and the network component 410 may perform benchmarking and testing of the RIC by the processes discussed herein. In particular, as will be appreciated by those of ordinary skill in the art, control logic and/or automated routines for performing the techniques and steps described herein may be implemented by the system 200, the benchmarking and testing device 202, and the network component 410 either by hardware, software, or combinations of hardware and software. For example, suitable code may be accessed and executed by the one or more processors 204 on the system 200, the benchmarking and testing device 202, and the network component 410 to perform some or all of the techniques described herein. Similarly, application specific integrated circuits (ASICs) configured to perform some, or all of the processes described herein may be included in the one or more processors 204 on the system 200.

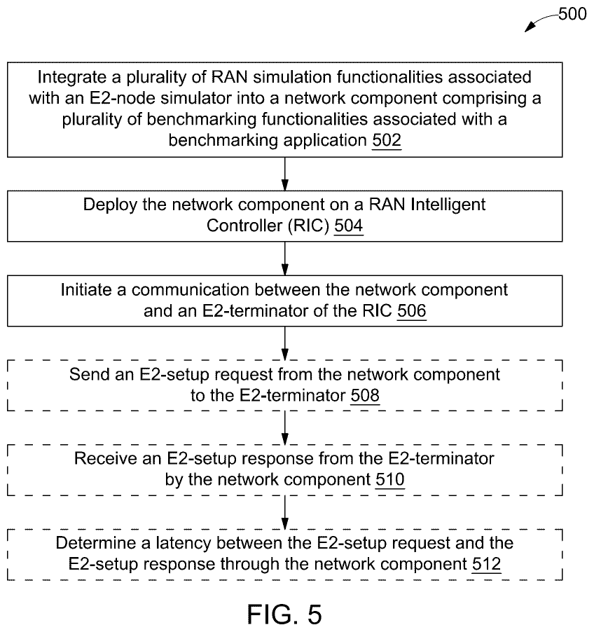

Referring now to FIG. 5, an exemplary method 500 for benchmarking and testing of a Radio Access Network (RAN) Intelligent Controller (RIC).is depicted via a flowchart, in accordance with some embodiments. FIG. 5 is explained in conjunction with FIGS. 1-4. Each step of the method 500 may be implemented by the benchmarking and testing device 202.

At step 502, a plurality of RAN simulation functionalities associated with the E2-node simulator 114 may be integrated into the network component 410 including a plurality of benchmarking functionalities associated with the benchmarking application 110. This step may be performed by the integration module 302. It should be noted that the plurality of RAN simulation functionalities from the E2-node simulator 114 may be combined with the plurality of benchmarking functionalities associated with the benchmarking application 110. This consolidation may generate a unified component (i.e., the network component 410) that may both simulate RAN behavior and perform benchmarking activities. The integration may create a comprehensive testing and benchmarking environment. It should be noted that the network component 410 including a combination of the plurality of RAN simulation functionalities and the plurality of benchmarking functionalities may be used for evaluating performance, responsiveness, and efficiency of the RIC under various conditions.

Further, at step 504, the network component 410 may be deployed on an RIC (such as the near RT-RIC 406 and the near RT-RIC 106). The RIC may be responsible for implementing intelligent control mechanisms within the RAN. This deployment of the network component 410 onto the RIC is to leverage capabilities of the network component 410 for benchmarking and testing the RIC. Thereafter, at step 506, a communication between the network component 410 and an E2-terminator (for example, an E2-terminator 412 and the E2-terminator 112) of the RIC may be initiated.

At step 508, to initiate the communication, an E2-setup request may be sent from the network component 410 to the E2-terminator 412. The E2-setup request may be a message including information about setup or configuration required for communication. For example, the network component 410 may send an E2-setup request to the E2-terminator 412, specifying parameters needed for interaction.

At step 510, an E2-setup response may be received from the E2-terminator 412 by the network component 410, in response to sending the E2-setup request. The E2-setup response acknowledges the E2-setup request and may include additional information. For example, the E2-terminator 412 may establish necessary configuration, and respond with the E2-setup response, indicating that the setup is complete.

Thereafter, at step 512, a latency between the E2-setup request and the E2-setup response may be determined through the network component 410. Once the E2-setup request is sent to the E2-terminator 412, the network component 410 may measure time taken to receive the E2-setup response. This duration may be referred to as the latency that represents the time delay between initiation of the communication and the acknowledgment received. For example, the network component may record timestamps when the E2-setup request is sent and when the E2-setup response is received. Further, the latency may then be calculated as a difference between these two timestamps.

Further, in some embodiments, a subscription request latency may be determined through the network component 410. The subscription request latency may be referred to time taken between sending a subscription request from the network component 410 to the E2-terminator 412 and receiving the subscription request from the E2-terminator 412 by the network component 410. Also, in some embodiments, an indication request latency may be determined through the network component 410. The indication request latency may be referred to time taken between sending an indication request from the network component 410 to the E2-terminator 412 and receiving the indication request from the E2-terminator 412 by the network component 410. Additionally, in some embodiments, potential E2-connections may be determined, and one or more E2-nodes may be configured, through the network component 410.

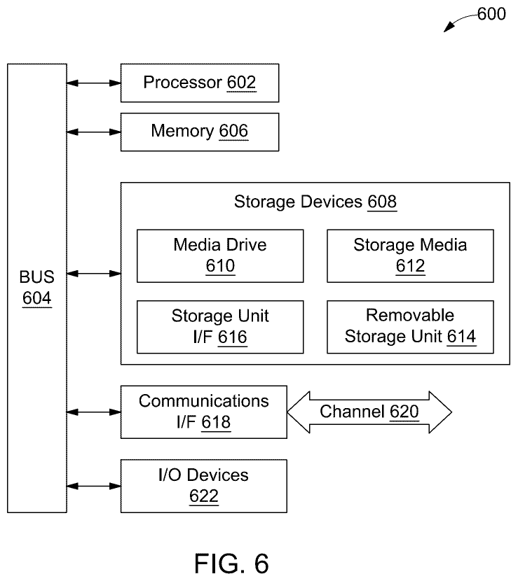

The disclosed methods and systems may be implemented on a conventional or a general-purpose computer system, such as a personal computer (PC) or server computer. Referring now to FIG. 6, an exemplary computing system 600 that may be employed to implement processing functionality for various embodiments (e.g., as client device, server device, one or more processors, or the like) is illustrated. Those skilled in the relevant art will also recognize how to implement the invention using other computer systems or architectures. The computing system 600 may represent, for example, a user device such as a desktop, a laptop, a server, and so on, or any other type of special or general-purpose computing device as may be desirable or appropriate for a given application or environment. The computing system 600 may include one or more processors, such as a processor 602 that may be implemented using a general or special purpose processing engine such as, for example, a microprocessor, microcontroller or other control logic. In this example, the processor 602 is connected to a bus 604 or other communication medium. In some embodiments, the processor 602 may be an Artificial Intelligence (AI) processor, which may be implemented as a Tensor Processing Unit (TPU), or a graphical processor unit, or a custom programmable solution Field-Programmable Gate Array (FPGA).

The computing system 600 may also include a memory 606 (main memory), for example, Random Access Memory (RAM) or other dynamic memory, for storing information and instructions to be executed by the processor 602. The memory 606 also may be used for storing temporary variables or other intermediate information during execution of instructions to be executed by the processor 602. The computing system 600 may likewise include a read only memory (“ROM”) or other static storage device coupled to bus 604 for storing static information and instructions for the processor 602.

The computing system 600 may also include a storage device 608, which may include, for example, a media drive 610 and a removable storage interface. The media drive 610 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 612 may include, for example, a hard disk, magnetic tape, flash drive, or other fixed or removable medium that is read by and written to by the media drive 610. As these examples illustrate, the storage media 612 may include a computer-readable storage medium having stored therein particular computer software or data.

In alternative embodiments, the storage devices 608 may include other similar instrumentalities for allowing computer programs or other instructions or data to be loaded into the computing system 600. Such instrumentalities may include, for example, a removable storage unit 614 and a storage unit interface 616, such as a program cartridge and cartridge interface, a removable memory (for example, a flash memory or other removable memory module) and memory slot, and other removable storage units and interfaces that allow software and data to be transferred from the removable storage unit 614 to the computing system 600.

The computing system 600 may also include a communications interface 618. The communications interface 618 may be used to allow software and data to be transferred between the computing system 600 and external devices. Examples of the communications interface 618 may include a network interface (such as an Ethernet or other NIC card), a communications port (such as for example, a USB port, a micro USB port), Near field Communication (NFC), etc. Software and data transferred via the communications interface 618 are in the form of signals which may be electronic, electromagnetic, optical, or other signals capable of being received by the communications interface 618. These signals are provided to the communications interface 618 via a channel 620. The channel 620 may carry signals and may be implemented using a wireless medium, wire or cable, fiber optics, or other communications medium. Some examples of the channel 620 may include a phone line, a cellular phone link, an RF link, a Bluetooth link, a network interface, a local or wide area network, and other communications channels.

The computing system 600 may further include Input/Output (I/O) devices 622. Examples may include, but are not limited to a display, keypad, microphone, audio speakers, LED lights, etc. The I/O devices 622 may receive input from a user and also display an output of the computation performed by the processor 602. In this document, the terms “computer program product” and “computer-readable medium” may be used generally to refer to media such as, for example, the memory 606, the storage devices 608, the removable storage unit 614, or signal(s) on the channel 620. These and other forms of computer-readable media may be involved in providing one or more sequences of one or more instructions to the processor 602 for execution. Such instructions, generally referred to as “computer program code” (which may be grouped in the form of computer programs or other groupings), when executed, enable the computing system 600 to perform features or functions of embodiments of the present invention.

In an embodiment where the elements are implemented using software, the software may be stored in a computer-readable medium and loaded into the computing system 600 using, for example, the removable storage unit 614, the media drive 610 or the communications interface 618. The control logic (in this example, software instructions or computer program code), when executed by the processor 602, causes the processor 602 to perform the functions of the invention as described herein.

Thus, the disclosed method and system try to overcome the technical problem discussed above. The disclosure provides amalgamation of basic functionalities of the E2-node simulator into a benchmarking application, establishing a streamlined and cost-effective solution. It should be noted that unification of these components helps achieve comprehensive latency measurement, addressing the challenging task of gauging latency at various levels within a RAN Intelligent Controller (RIC). This integration not only simplifies a benchmarking process but also mitigates the need for separate and costly third-party E2-node simulators. Consequently, the disclosure offers a substantial cost-saving benefit, making it an economically efficient solution for RIC benchmarking. Furthermore, this consolidated system enhances overall operational efficiency, fostering a more seamless and integrated environment for comprehensive latency assessment within an RIC architecture.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for benchmarking and testing of a Radio Access Network (RAN) Intelligent Controller (RIC). The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of benchmarking and testing of a Radio Access Network (RAN) Intelligent Controller (RIC), the method comprising:
integrating, by a benchmarking and testing device, a plurality of RAN simulation functionalities associated with an E2-node simulator into a network component comprising a plurality of benchmarking functionalities associated with a benchmarking application;
deploying, by the benchmarking and testing device, the network component on a RAN Intelligent Controller (RIC); and
initiating, by the benchmarking and testing device, a communication between the network component and an E2-terminator of the RIC.

2. The method of claim 1, wherein initiating the communication further comprises sending an E2-setup request from the network component to the E2-terminator.

3. The method of claim 2, further comprising receiving an E2-setup response from the E2-terminator by the network component.

4. The method of claim 3, further comprising determining a latency between the E2-setup request and the E2-setup response through the network component.

5. The method of claim 1, further comprising configuring one or more E2-nodes via the network component.

6. The method of claim 5, further comprising determining potential E2-connections on the RIC through the network component.

7. The method of claim 1, further comprising determining a control request latency based on time taken between sending a control request from the network component to the E2-terminator and receiving the control request from the E2-terminator by the network component.

8. The method of claim 1, further comprising determining a subscription request latency based on time taken between sending a subscription request from the network component to the E2-terminator and receiving the subscription request from the E2-terminator by the network component.

9. The method of claim 1, further comprising determining an indication request latency based on time taken between sending an indication request from the network component to the E2-terminator and receiving the indication request from the E2-terminator by the network component.

10. A system for benchmarking and testing of a Radio Access Network (RAN) Intelligent Controller (RIC) comprising a benchmarking and testing device, wherein the benchmarking and testing device comprises:
a processor; and
a memory communicatively coupled to the processor, wherein the memory stores processor-executable instructions, which, on execution, cause the processor to:
integrate a plurality of RAN simulation functionalities associated with an E2-node simulator into a network component comprising a plurality of benchmarking functionalities associated with a benchmarking application;
deploy the network component on a RAN Intelligent Controller (RIC); and
initiate a communication between the network component and an E2-terminator of the RIC.

11. The system of claim 10, wherein the processor-executable instructions further cause the processor to initiate the communication by sending an E2-setup request from the network component to the E2-terminator.

12. The system of claim 11, the processor-executable instructions further cause the processor to receive an E2-setup response from the E2-terminator by the network component.

13. The system of claim 12, wherein the processor-executable instructions further cause the processor to determine a latency between the E2-setup request and the E2-setup response through the network component.

14. The system of claim 10, wherein the processor-executable instructions further cause the processor to configure one or more E2-nodes via the network component.

15. The system of claim 14, wherein the processor-executable instructions further cause the processor to determine potential E2-connections on the RIC through the network component.

16. The system of claim 10, wherein the processor-executable instructions further cause the processor to determine a control request latency based on time taken between sending a control request from the network component to the E2-terminator and receiving the control request from the E2-terminator by the network component.

17. The system of claim 10, wherein the processor-executable instructions further cause the processor to determine a subscription request latency based on time taken between sending a subscription request from the network component to the E2-terminator and receiving the subscription request from the E2-terminator by the network component.

18. The system of claim 10, wherein the processor-executable instructions further cause the processor to determine an indication request latency based on time taken between sending an indication request from the network component to the E2-terminator and receiving the indication request from the E2-terminator by the network component.

19. A network component deployed on a RAN Intelligent Controller (RIC) comprising:
a plurality of RAN simulation functionalities associated with an E2-node simulator; and
a plurality of benchmarking functionalities associated with a benchmarking application, wherein the plurality of RAN simulation functionalities is integrated with the plurality of benchmarking functionalities.

20. The network component of claim 19, wherein:
an E2-setup request is sent to an E2-terminator of the RIC;
an E2-setup response is received from the E2-terminator upon sending the E2-setup request to the E2-terminator; and
a latency between the E2-setup request and the E2-setup response is determined.
